(19) United States
(12) Patent Application Publication
(10) Pub. No.: US 2003/0075507 A1
(43) Pub. Date: Apr. 24, 2003

(54) Membrane system and method for separating a hydrocarbon fluid and a disposal fluid and dispersing the disposal fluid into a body of water

(76) Inventors: Curtis L. Munson, Oakland, CA (US); Michael Dubrovsky, Richmond, CA (US)

Correspondence Address: T. Gene Dillahunty, Esq., BURNS, DOANE, SWECKER & MATHIS, L.L.P., P.O. Box 1404, Alexandria, VA, 22313-1404, US

(21) Appl. No.: 10/084,882

(22) Filed: Oct. 24, 2001

(51) Int. Cl. B01D 61/00

(52) U.S. Cl. 210/649; 210/650; 210/749; 210/321.87

(57) ABSTRACT

A system and method for separating a hydrocarbon fluid stream and a disposal fluid stream and for dispersing the disposal fluid stream into a body of water. The system includes a production string located in a body of water, and a membrane positioned in the production string for separating the hydrocarbon fluid and the disposal fluid by passing the disposal fluid through the membrane. The membrane separation system provides an efficient solution to disperse disposal fluids removed from a hydrocarbon production stream into a body of water in a controllable and ecologically friendly manner.

### FIELD OF THE INVENTION

The invention relates to a system and method for separating a hydrocarbon fluid and a disposal fluid in a hydrocarbon production fluid, and more particularly, the invention relates to a membrane system for separating a hydrocarbon fluid from a disposal fluid, and dispersing the disposal fluid into a body of water.

### BACKGROUND OF THE INVENTION AND BRIEF DESCRIPTION OF THE RELATED ART

Hydrocarbon gases and liquids are recovered from underground wellbores by drilling a wellbore into a hydrocarbon gas or liquid containing formation and withdrawing the materials under reservoir pressure or by artificial lifting. The fluids withdrawn from the reservoir consist of a combination of hydrocarbon liquids and gases, water, sediments, and other undesirable fluids or contaminants which are to be disposed.

The current recovery technology involves removing the hydrocarbon fluids and any disposal fluids, which are present from the wellbore, and separating the disposal fluids from the hydrocarbon fluids above ground. This above ground separation is costly. The disposal fluids, which may be produced, include carbon dioxide, nitrogen, water vapor, hydrogen sulfide, helium, other trace gases, water, water soluble organics, and others.

Oceans or bodies of water cover more than 75 percent of the Earth's surface. Accordingly, great quantities of hydrocarbons are being found underneath the ocean. As a result of the expenses incurred with the drilling for hydrocarbons underneath the ocean from offshore platforms, the disposal of disposal fluids is also costly. What is desired is a system and method of dispersing disposal fluids such as carbon dioxide into the ocean or other body of water to help promote ecological enhancement, to reduce the cost of recovery of hydrocarbons, and to reduce pollution of the atmosphere and biosphere.

One of the disposal fluids which may be produced from a producing wellbore or a production stream is carbon dioxide or CO₂. Carbon dioxide is known as the “greenhouse gas,” as a result of its ability to absorb infrared radiation emitted by the earth, thus leading to increased surface temperatures. Unfortunately, one of the reasons for an increase in atmospheric carbon dioxide is due to the burning of fossil fuels like coal and oil. However, not all the carbon dioxide generated by fossil fuel burning stays in the atmosphere. Some of the carbon dioxide accumulates in the atmosphere, some is taken up by the terrestrial biosphere, and the ocean absorbs some.

In order to reduce the greenhouse effect, scientists are looking into the possibility of disposing carbon dioxide into the ocean. Generally, carbon dioxide is more soluble in water than gases like oxygen or nitrogen. Thus, the ocean has a greater ability to hold carbon dioxide than the atmosphere and biosphere.

In addition, carbon dioxide can be transferred from the atmosphere to the ocean, or from the ocean to the atmosphere. The transfer of carbon dioxide through the ocean surface is controlled by a chemical equilibrium between its “partial pressure,” that is the pressure exerted by each element in a gas mixture and its concentration in the ocean. If the partial pressure of the carbon dioxide just above the ocean surface is larger than it should be for the existing carbon dioxide concentration in the ocean (as dictated by the chemical equilibrium), then carbon dioxide is transferred from the atmosphere into the ocean (and vice versa if the partial pressure is reversed). The rate of transfer is also affected by the ocean water's chemical composition and temperature and by the ocean surface's resistance to gas exchange, which depends on wind speed and the state of the sea surface, and the presence or absence of breaking waves.

Accordingly, it would be desirable to provide a system and method for separating hydrocarbons and disposal fluids, particularly carbon dioxide, and dispersing the disposal fluids into a body of water using a membrane separation system.

### SUMMARY OF THE INVENTION

The present invention provides an efficient solution to dispersing disposal fluids into a body of water from a wellbore producing a mixture of hydrocarbons and disposal fluids.

In accordance with one aspect of the present invention, a system for separating a hydrocarbon fluid and a disposal fluid by dispersing the disposal fluid into a body of water includes a production string located in a body of water; and a membrane positioned in the production string for separating the hydrocarbon fluid and the disposal fluid by passing the disposal fluid through the membrane. A disposal fluid output side of the membrane releases the disposal fluid into the body of water.

In accordance with another aspect of the present invention, a method for separating a hydrocarbon fluid and a disposal fluid by dispersing the disposal fluid into a body of water includes the steps of positioning a production string in a body of water; separating the hydrocarbon fluid and the disposal fluid in the production string with a membrane by passing the disposal fluid through the membrane. The membrane is configured to be positioned in the production string and the disposal fluid is released into the body of water.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 is a perspective view of a membrane cartridge or element for separating hydrocarbons from disposal fluids;

FIG. 2 is a schematic side cross-sectional view of a membrane cartridge or element for separating hydrocarbons from disposal fluids in a production string;

FIG. 3 is a schematic side cross-sectional view according to a first embodiment of a separation system for dispersing disposal fluids into a body of water;

FIG. 4 is a schematic side cross-sectional view of a production string in a hydrocarbon producing formation and a separation system for dispersing disposal fluids into a body of water;

FIG. 5 is a schematic side cross-sectional view according to an alternative embodiment of a separation system with tubes for dispersing disposal fluids into a body of water;

FIG. 6 is a schematic side cross-sectional view according to another embodiment of a separation system with rigid tubes for dispersing disposal fluids into a body of water;

FIG. 7 is a schematic side cross-sectional view according to an alternative embodiment of a separation system with flexible tubes for dispersing disposal fluids into a body of water;

FIG. 8 is a schematic side cross-sectional view according to an alternative embodiment of a separation system with a cleaning device for dispersing disposal fluids into a body of water; and

FIG. 9 is a flow diagram illustrating a method for separating a hydrocarbon fluid and a disposal fluid by dispersing the disposal fluid into a body of water.

### DETAILED DESCRIPTION OF THE PREFERRED EMBODIMENTS

Membrane separation systems are used for separating disposal fluids from hydrocarbon liquids and gases in a wellbore of a production string. Generally, the disposal fluids which are removed are reinjected into an underground disposal formation or removed to the surface for disposal. However, it would be desirable under certain conditions to release disposal fluids such as carbon dioxide into a body of water. Accordingly, the present invention discloses a system and method for dispersing disposal fluids into a body of water. Of course, the fluids to be dispersed should be within applicable environmental guidelines and regulations. Fluids which do not meet these guidelines and regulations should not be permeated through the membrane and allowed to be dispersed into a body of water.

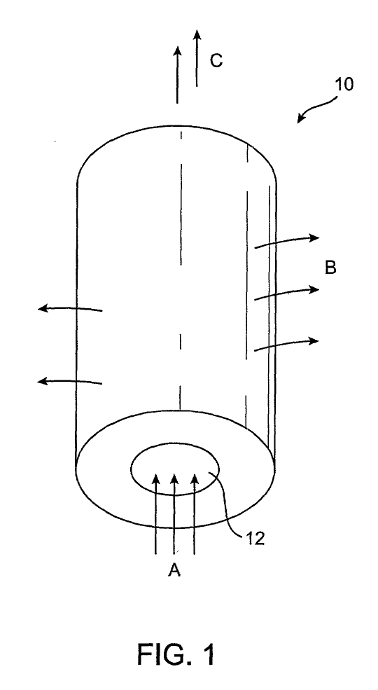

FIG. 1 illustrates one example of a membrane cartridge or element 10 formed of a preferentially selective material for permeating disposal fluids. The membrane element 10 is a tubular element having a central bore 12 through which the hydrocarbons and disposal fluids pass in the direction indicated by the arrows A. The disposal fluids permeate out through the preferentially selective material as indicated by the arrows B, while the hydrocarbons continue out the top of the membrane element as indicated by the arrows C. Preferably, the membrane elements 10 would be stacked to form a membrane separation system.

Each one of the stacked membrane elements 10 may be designed to permeate one or more of the disposal fluids which are present in the well. For example, one membrane element 10 may be designed for the removal of carbon dioxide, a second for removal of hydrogen sulfide, and a third for removal of water.

Although a hollow fiber or tubular shaped membrane formed of multiple membrane elements is described herein, other membrane shapes may also be used. Some other membrane shapes include spirally wound, pleated, flat sheet, or polygonal tubes. The uses of multiple hollow fiber membrane tubules have been selected for their large fluid contact area. The contact area may be further increased by adding additional tubules or tube contours.

The membranes may be stacked in different arrangements to remove disposal fluids from the flow of hydrocarbon fluid in different orders depending on the application. The number, type, and configuration of the membranes may vary depending on the particular well. The separation system may be specifically designed for a particular well taking into account the type and amounts of hydrocarbon fluids and disposal fluids present in the well, and the well configuration. The membranes may also be of a variable length depending on the particular application. The membranes may even be stacked to extend along the entire length of the wellbore or production string for maximum disposal fluid removal.

The passage of the disposal fluids through the membrane is controlled by the difference in partial pressures of the disposal fluids on opposite sides of the membrane. This partial pressure difference provides the driving force which drives the disposal fluids through the membrane. When the partial pressure difference becomes small due to accumulation of removed disposal fluids, the removal of the contaminates will slow and eventually stop. Thus, it is important to move the disposal fluids away from the output side of the membrane.

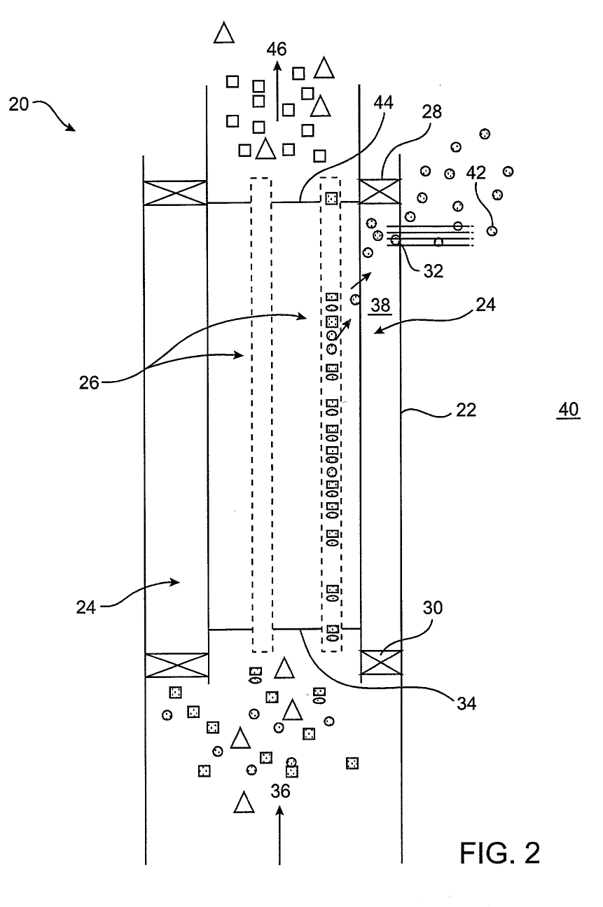

FIG. 2 illustrates one example of a membrane separation system 20 with a plurality of parallel membrane tubules 26 for separating hydrocarbons from disposal fluids in a production string and dispersing the disposal fluids into a body of water 40. The system 20 includes an outer perforated tube or casing 22 and an inner tube 24 positioned within the outer tube 22. A plurality of membrane tubules 26 are positioned in the inner tube 24 for separating hydrocarbons and disposal fluids. A first packer 28 and a second packer 30 provide a seal between the inner tube 24 and the outer tube 22 isolating a disposal fluid collection zone 38 from a production stream 36. The hydrocarbons and disposal fluids enter the membrane separation system 20 through an entrance end 34. As the production stream 36 including a hydrocarbon fluid and one or more disposal fluids pass through the membrane tubule 26 in the inner tube 24, one or more disposal fluids permeate out through the membrane tubule 26. The separated disposal fluids 42 permeating out through the membrane tubule 26 are collected in the disposal fluid collection zone 38, and are dispersed into the body of water 40 through perforations 32 of the outer perforated tube or casing 22. The pressure inside the membrane tubule 26 is maintained at a pressure greater than the pressure of the water into which the disposal fluids are dispersed. This prevents any possible convective flow of water back through the membrane system and also reduces any counter diffusion through the membrane of water vapor back into the stream of hydrocarbons and other unpermeated fluids. The hydrocarbon fluid plus any remaining fluids 46 that were not removed by the membrane tubule 26 continue out of the membrane tubules 26 through an exit end 44 of the inner tube 24 to the surface or to another separation system.

FIG. 2 illustrates a plurality of membrane tubules 26 for purposes of illustration. However, a membrane separation systems may include one or more membranes tubules arranged in series or parallel.

The membrane separation system is placed inside the production tubing (not shown) of a well and can be easily deployed by a deployment tool and retrieved by a retrieval tool without the removal of the entire production string.

At the present time, carbon dioxide is sometimes used to enhance the flow of oil and natural gases by injection of the carbon dioxide into the production formation. However, not all sites are able to reuse removed carbon dioxide by the injection of carbon dioxide to enhance oil recovery. Accordingly, many oil companies are looking for alternative ways to dispose of carbon dioxide, including dispersing carbon dioxide into the ocean provided that environmental standards and applicable governmental regulations are met.

The ocean already holds a large quantity of dissolved carbon dioxide and has the capacity to hold even more. At this time, scientists are looking for ways to tap into the ocean's ability to store carbon dioxide. One way, is to separate the carbon dioxide from other gases, and pipe the carbon dioxide deep into the ocean. This may result in the formation of carbon dioxide hydrate with unknown stability. Alternatively and more preferably, excess carbon dioxide produced from oil and gas wells can be separated from the hydrocarbons and dispersed into the ocean to fertilize ocean waters, and encourage the growth of tiny plants including phytoplankton. Phytoplankton is found close to the surface of the water where there is adequate sunlight for photosynthesis. Phytoplankton is eaten by tiny floating animals known as zooplankton. The zooplankton, in turn, is food for fish, which millions of people depend on as a food source.

Accordingly, one approach to the disposal of excess carbon dioxide would be to release the carbon dioxide gas into the ocean. Preferably, the carbon dioxide would be released at depths of about 500 feet or less, where it would dissolve into the ocean. At this depth, the natural carbon dioxide absorbing capacity of the phytoplankton would absorb the excess carbon dioxide. During photosynthesis, phytoplankton absorbs the carbon dioxide and converts the carbon dioxide to other compounds. When the phytoplankton die, they carry their carbon with them into the watery depths, where the carbon is trapped on the ocean floor.

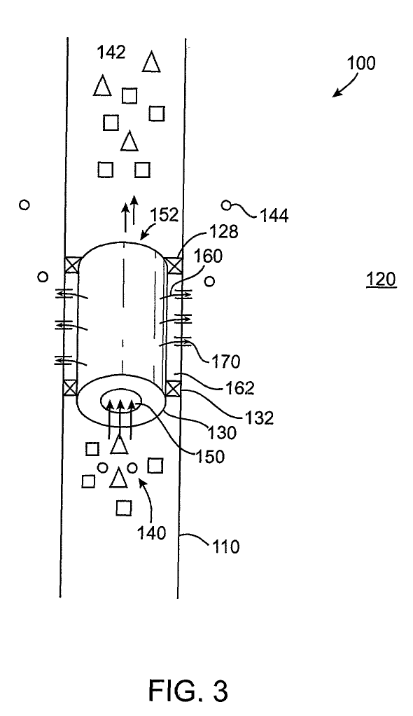

FIG. 3 illustrates a system 100 for separating a hydrocarbon fluid and a disposal fluid by disbursing the disposal fluids into a body of water. The system 100 includes a production string 110 located in a body of water 120. A membrane 130 for separating hydrocarbon fluids and disposal fluids 140 is located within the production string 110. As the mixture of hydrocarbons and disposal fluids 140 passes through the membrane 130 from an entrance end 150 to an exit end 152, one or more disposal fluids 144 permeate out through the membrane 130. The separated disposal fluids 144 are dispersed into the body of water 120 through perforations 170 in the production string 110. The hydrocarbon fluids plus any remaining disposal fluids 142 continue out an exit end 152 of the membrane 130 to the surface or to another separation system.

The membrane 130 for separating the hydrocarbon fluids and the disposal fluids 140 has an entrance end 150, an output side 160, and an exit end 152. The membrane 130 is configured to be positioned in the production string 110. A first packer 128 and a second packer 132 provide a seal between the membrane 130 and the production string 110 isolating a disposal fluid collection zone 162. The disposal fluid 144 is released into the body of water 120 from the output side 160 of the membrane 130 and disposal fluid collection zone 162. A single membrane unit designed for placement in the production string 110 can be used. However, it can be appreciated that any number and combination of membranes 130 can be used. In one embodiment as shown in FIG. 3, the membrane 130 is located within the production string 110 and the production string 110 has perforations 170 around the membrane 130 at a location between the packers 128, 132 to release the disposal fluids 144 into the body of water 120.

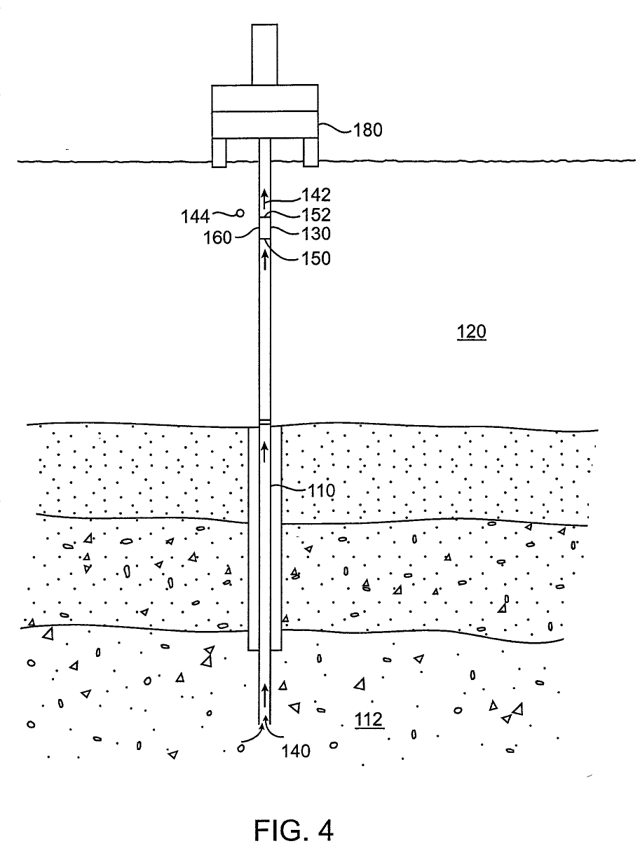

As shown in FIG. 4, the production string 110 is a series of tubes located in a hydrocarbon producing formation 112 and extends from the formation 112 to the surface or drilling platform 180. The hydrocarbon producing zone or formation 112 generally includes a sedimentary bed or deposit composed of substantially the same minerals throughout and distinctive enough to form a single unit. The production string 110 brings the well fluids to the surface or drilling platform 180 for separation, storing, and otherwise preparing the product for delivery to a pipeline and/or production center.

In operation, the hydrocarbons and disposal fluids 140 are produced from a hydrocarbon producing formation 112 under the water's surface. The hydrocarbons and disposal fluids 140 flow into the production string 110. As the hydrocarbons and disposal fluids 140 proceed through the production string 110, the flow of the hydrocarbons and disposal fluids 140 enter into the membrane 130 from an entrance end 150. The hydrocarbons and any remaining disposal fluids 142 pass through the membrane 130 and continue out the exit end 152 of the membrane 130 to the surface. Meanwhile, the disposal fluids 144 permeate through the membrane 130, exit from an output side 160 of the membrane 130 and are released into the body of water 120.

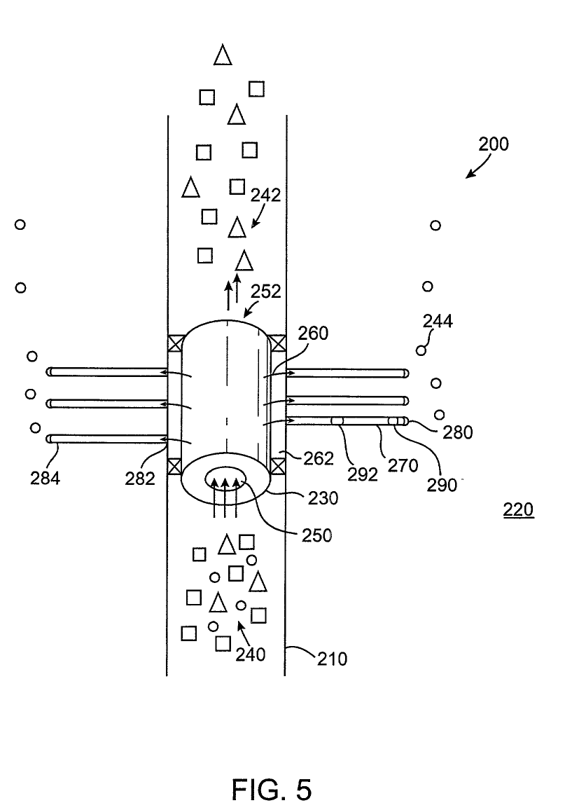

FIG. 5 illustrates an alternative embodiment of a separation system for disbursing disposal fluids into a body of water. The system 200 includes a production string 210 located in a body of water 220. A membrane 230 for separating hydrocarbons and disposal fluids 240 is located within the production string 210. As the mixture of hydrocarbons and disposal fluids 240 passes through the membrane 230 one or more disposal fluids 244 permeate out through the membrane 230 into a disposal fluid collection zone 262 and then into one of a plurality of tubes 270. The tubes 270 are preferably made of an untrafiltration or microfiltration membrane which is ideally hydrophilic. The membranes may be supported on a porous substructure to insure adequate strength. The hydrocarbons plus any remaining disposal fluids 242 continue out an exit end 252 of the membrane 230 to the surface or to another separation system. The tubes 270 extend from the production string 210 into the body of water 220 and disburse the separated disposal fluid 244. The tubes 270 each have a first end 282 attached to the production string 210 and a second end 284 extending into the body of water 220. The disposal fluid 244 is released into the body of water 220 through the second end 284 of the tubes 270. It can be appreciated that the tubes 270 alternatively may be made of PVC, plastic, rubber, metal or any other material which can withstand the conditions of the ocean and/or body of water. The advantage of using tubes 270 is that they disperse carbon dioxide and other permeated fluids over a larger volume of water than provided by dispersed directly from perforations in production string 210. The tubes 270 also have a tendency to help disperse carbon dioxide gas in water and help in overcoming resistance to local mass transfer which is inherent in diffusion limited processes.

The tubes 270 extending from the production string 210 will vary in size depending on the application. Preferably, the tubes are from about a quarter inch in diameter to four inches in diameter. The diameter of the tubing will, more preferably, be between about one half inch to about three-quarters of an inch in diameter. The lengths of the tubes 270 may be all substantially the same or may be varied to more widely disperse the disposal fluid.

In an alternative embodiment, also shown in FIG. 5, the tubes 270 will have a nozzle 280 located at the second end 284 of the tubes 270. The nozzle 280 regulates the flow of disposal fluids 244 through the tubes 270. The nozzle 280 can also be controlled by an intelligent completion device 290. The intelligent completion device 290 monitors the flow of disposal fluids and/or the disposal fluid concentration in the body of water 220 and control the nozzles 280 to increase or decrease the release of the disposal fluids 244 into the body of water 220.

In a further embodiment, as shown in FIG. 5, an additive 292 is added to the disposal fluid 244 as it passes through the tubes 270 before the disposal fluid 244 is released into the body of water 220. In a preferred embodiment, the additive will be a calcium carbonate which controls the acidity of the carbon dioxide. By bubbling carbon dioxide through a calcium carbonate, (seashells may be used as a source of calcium carbonate), the carbon dioxide becomes a chemically neutral and harmless gas. The calcium carbonate may be in the form of a coating or inserted within the tubes 270 or the disposal fluid collection zone 262.

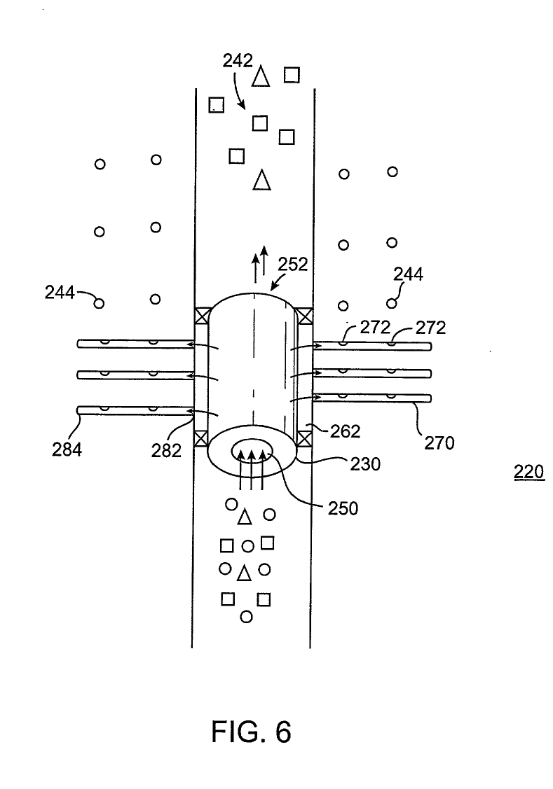

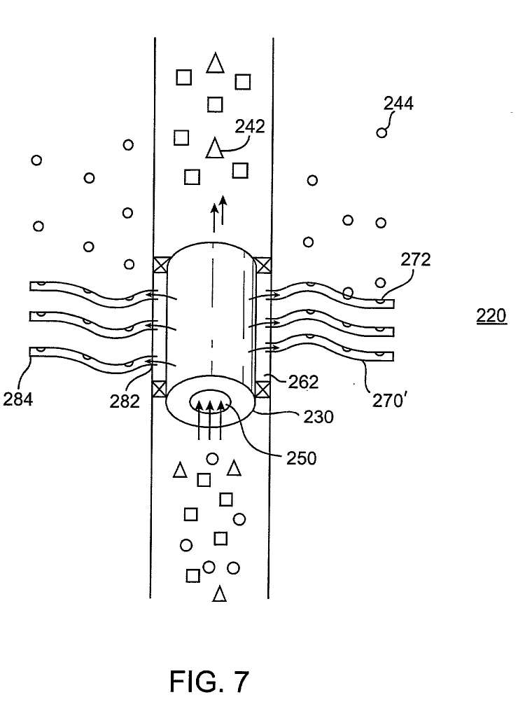

FIGS. 6 and 7 illustrate alternative embodiments of the system for separating hydrocarbon fluids and disposal fluids. The tubes 270 are capped at the second end 284 and have a plurality of perforations 272 for releasing the disposal fluids 244 into the ocean or body of water 220. It can be appreciated that the tubes 270 can be rigid (FIG. 6) or flexible (FIG. 7). The flexible tubes 270′ may be made of ultrahigh filtration or else rubber or other materials and provide improved dispersion of the disposal fluids throughout the water surrounding the membrane separation system.

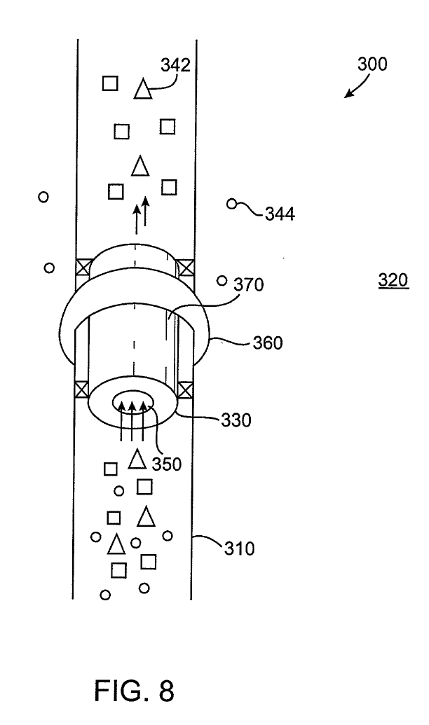

FIG. 8 illustrates an alternative embodiment of a system 300 for separating a hydrocarbon fluid and a disposal fluid by dispersing the disposal fluid into a body of water. The embodiment of FIG. 8 includes a cleaning device 360 which is located on an output side 370 of a membrane 330 and/or a production string 310 to remove hydrates. Under certain temperatures and pressures, hydrates will form as a result of releasing a disposal fluid such as carbon dioxide into a body of water. The hydrates or solids will form on the output side 370 of the membrane separator 330 and/or production string 310. In order to remove the hydrates from the output side 370 of the membrane separator 330 or production string 310, a cleaning device 360 is located on the output side 370 of the membrane separator 330 and/or production string 310. The cleaning device 360 will remove the hydrates from the output side 370 of the membrane 330 and/or production string 310 with a scraping motion. The cleaning device 360 will move from one position to another and back. In the preferred embodiment, the cleaning device 360 is in the form of a movable circular device surrounding the production string. Alternatively, individual cleaning devices could be installed for removing hydrates from specific output tubes.

The disposal fluids can include any gas and/or liquid which meets appropriate environmental standards. For example, carbon dioxide is probably the most prevalent disposal fluid produced by oil and gas wells. In addition, the release of carbon dioxide into the sea will promote or reduce the greenhouse effect, and can increase oceanic life by increasing vital phytoplankton production. In addition to carbon dioxide, other preferred disposal fluids to be released into the body of water include water and nitrogen.

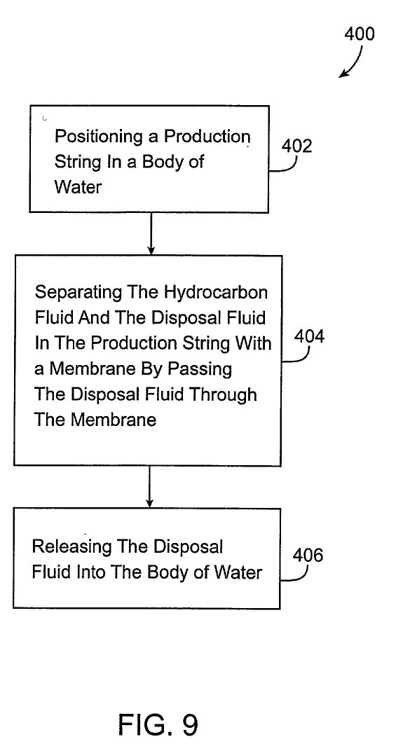

FIG. 9 illustrates a method 400 for separating a hydrocarbon fluid and a disposal fluid by dispersing the disposal fluid into a body of water. The method includes positioning a production string in a body of water 402 and separating the hydrocarbon fluid and the disposal fluid in the production string with a membrane by passing the disposal fluid through the membrane 404. The membrane is configured to be positioned in the production string. The separated disposal fluid is released into the body of water 406.

In a further embodiment, a further step of positioning a cleaning device on the output side of the membrane to remove hydrates will be used. The cleaning device will remove hydrates formed as a result of the union of the disposal fluid and water.

The membranes according to the present invention are selected to be durable, resistant to high temperatures, and resistant to exposure to liquids. The materials may be coated or otherwise protected to help prevent fouling and improve durability. Examples of suitable membrane materials for removal of disposal fluids from a hydrocarbon gas stream include cellulose acetate, polysulfones, polyimides, cellulose triacetate (CTA), carbon molecular sieve membranes, ceramic and other inorganic membranes, composites comprising any of the above membrane materials with another polymer, composite polymer and molecular sieve membranes including polymer zeolite composite membranes, polytrimethylsilene (PTMSP), and rubbery polymers.

Some examples of polyimides are the asymmetric aromatic polyimides in hollow fiber or flat sheet form. Patents describing these include U.S. Pat. Nos. 5,234,471 and 4,690,873.

Some examples of carbon molecular sieve membranes are those prepared from the pyrolysis of asymmetric aromatic polyimide or cellulose hollow fibers. Patents describing these include European Patent Application 0 459 623 and U.S. Pat. No. 4,685,940. These fibers may be coated with a separate polymer or post-treated after spinning to increase resistance to high humidity and impurities, such as in U.S. Pat. Nos. 5,288,304 and 4,728,345.

The number, type, and configuration of the membranes may vary depending on the particular well. The separation system may be specifically designed for a particular well taking into account the type and amounts of hydrocarbon fluids and disposal fluids present in the well, and the well configuration.

The separation systems of the present invention have been illustrated in schematic form for ease of illustration. However, the separation systems may be incorporated in strings which may include one or more membranes, fluid directing elements, shear-out subs, fishing neck subs, seal assemblies, pack-off assemblies, and any other subs together in a configuration which is selected depending on the properties of a particular well. The assembled separation string may be lowered into a production tubing or may be assembled within a production tubing. The separation string is preferably deployable and retrievable with conventional deployment and retrieval tools.

Although the separation system of the present invention has been illustrated for use in a vertical well it should be understood that the invention may be employed in horizontal wells and other non-vertical wells.

Each of the membranes preferentially permeates one or more disposal fluids and excludes hydrocarbons. Although membrane materials are imperfect they can be used to greatly decrease the amount of disposal fluids which are brought to the surface and must be separated and disposed of by surface separation technology.

The present invention may be combined with existing downhole technologies for mechanical physical separation systems, such as cyclones or centrifugal separation systems. The invention may also be used for partial removal of the disposal fluids to reduce the burden on surface removal facilities with the remaining disposal fluids removed by conventional surface technologies. Some types of separated disposal fluids such as carbon dioxide can be reinjected into the production zone to maintain pressurization of the reservoir.

While the invention has been described in detail with reference to the preferred embodiments thereof, it will be apparent to one skilled in the art that various changes and modifications can be made and equivalents employed, without departing from the present invention.

What is claimed is:

1. A system for separating a hydrocarbon fluid and a disposal fluid by dispersing the disposal fluid into a body of water, the system comprising:
a production string located in a body of water; and
a membrane positioned in the production string for separating the hydrocarbon fluid and the disposal fluid by passing the disposal fluid through the membrane, and wherein a disposal fluid output side of the membrane releases the disposal fluid into the body of water.

2. The system according to claim 1, wherein the production string is perforated around the membrane.

3. The system according to claim 1, wherein the membrane has a tube extending from the membrane for dispersing the separated disposal fluid into the body of water.

4. The system according to claim 1, wherein the membrane has a plurality of tubes extending from the membrane for dispersing the separated disposal fluid.

5. The system according to claim 4, wherein the tubes are flexible.

6. The system according to claim 4, wherein the tubes are capped and have a plurality of perforations for releasing the disposal fluid.

7. The system according to claim 4, wherein the tubes have a nozzle which regulates the release of disposal fluids.

8. The system according to claim 1, wherein an additive is added to the disposal fluid before the disposal fluid is released into the body of water.

9. The system according to claim 8, wherein the additive is calcium carbonate.

10. The system according to claim 1, wherein the disposal fluid is a gas.

11. The system according to claim 1, wherein the disposal fluid is a liquid.

12. The system according to claim 1, wherein the disposal fluid is carbon dioxide.

13. The system according to claim 1, wherein the disposal fluid is water.

14. The system according to claim 1, wherein a cleaning device is located on the output side of the membrane to remove hydrates.

15. The system according to claim 1, wherein the system is configured to release bubbles of disposal fluid having a bubble size between about 1 milliliter to about 1 liter.

16. The system according to claim 1, wherein the membrane is a tubular membrane.

17. The system according to claim 1, wherein a plurality of membranes are located in the production string.

18. The system according to claim 1, further comprising a plurality of membrane units configured to be positioned in the production string for separating disposal fluids from a hydrocarbon.

19. The system according to claim 18, wherein the plurality of membrane units include a membrane unit for removal of carbon dioxide and a membrane unit for removal of water.

20. The system according to claim 1, wherein the membrane can be removed and replaced.

21. The system according to claim 1, further comprising a perforated tubular liner surrounding the membrane.

22. The system according to claim 1, further comprising an intelligent completion device located within the production string and configured to control release of the disposal fluids into the body of water.

23. The system according to claim 22, wherein the intelligent completion device controls a nozzle located within a tube extending from the membrane for dispersing the separated disposal fluids into the body of water.

24. A method for separating a hydrocarbon fluid and a disposal fluid by dispersing the disposal fluid into a body of water, the method comprising:
positioning a production string in a body of water;
separating the hydrocarbon fluid and the disposal fluid in the production string with a membrane by passing the disposal fluid through the membrane, the membrane configured to be positioned in the production string; and
releasing the separated disposal fluid into the body of water.

25. The method according to claim 24, further comprising a step of positioning a cleaning device on the output side of the membrane to remove hydrates.

26. The method according to claim 24, wherein the step of separating the hydrocarbon fluid and disposal fluid comprises separating carbon dioxide from the hydrocarbon.

27. The method according to claim 24, wherein the step of separating the hydrocarbon fluid and disposal fluid comprises separating water from the hydrocarbon.

28. The method according to claim 24, further comprising a step of positioning a plurality of membranes in the production string for separating the hydrocarbons and disposal fluids.

29. The method according to claim 24, further comprising a step of adding an additive to the disposal fluid before the disposal fluid is released into the body of water.

30. The method according to claim 24, further comprising regulating the release of the disposal fluid.

31. The method according to claim 24, wherein the step of regulating the release of disposal fluids is performed by use of a nozzle.
